(19) United States
(12) Patent Application Publication
(10) Pub. No.: US 2025/0252440 A1
(43) Pub. Date: Aug. 7, 2025

(54) AUTOMATED CHANNEL MANAGEMENT FOR A SECOND-LAYER PAYMENT PROTOCOL NETWORK VIA DISCRETE OPTIMIZATION AND SIMULATION

(71) Applicant: Stillmark Management LLC, Los Angeles, CA (US)

(72) Inventor: Vikash R. Singh, San Francisco, CA (US)

(21) Appl. No.: 18/433,292

(22) Filed: Feb. 5, 2024

(51) Int. Cl. G06Q 20/40; G06Q 20/06

(52) U.S. Cl. CPC G06Q 20/4014; G06Q 20/065; G06Q 2220/00

(57) ABSTRACT

A method for managing channels including, by a computing device, receiving a join request from a user corresponding to a request to establish one or more channels with respective user nodes of a plurality of user nodes in a second-layer payment protocol network configured to process transactions between users associated with a cryptocurrency network, obtaining information about the second-layer payment protocol network that indicates channels established between the plurality of user nodes and at least one of balances associated with the plurality of user nodes in the second-layer payment protocol network or balances associated with channels between two or more of the plurality of user nodes, simulating, based on the information obtained about the second-layer payment protocol network, a plurality of transactions between selected user nodes of the plurality of user nodes to obtain transaction simulation results that include at least reliability scores associated with the plurality of user nodes, identifying one or more recommended user nodes based on the transaction simulation results and the information obtained about the second-layer payment protocol network, and providing, to the user, an output indicating the one or more recommended user nodes.

### FIELD

The present disclosure relates to channel management for cryptocurrency networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Bitcoin, the oldest and most secure blockchain, uses a distributed ledger to record transactions. However, the scalability and transaction speed of Bitcoin is limited due to required consensus mechanisms and block size constraints. For example, Bitcoin's base layer can only handle 5-10 transactions per second. To address these limitations, the Lightning Network was introduced as a second-layer payment protocol network built on top of blockchain networks like Bitcoin. The Lightning Network enables off-chain, peer-to-peer transactions that are faster and cheaper compared to on-chain transactions.

### SUMMARY

Further areas of applicability of the present disclosure will become apparent from the detailed description, the claims, and the drawings. The detailed description and specific examples are intended for purposes of illustration only and are not intended to limit the scope of the disclosure.

A method for managing channels including, by a computing device, receiving a join request from a user corresponding to a request to establish one or more channels with respective user nodes of a plurality of user nodes in a second-layer payment protocol network configured to process transactions between users associated with a cryptocurrency network, obtaining information about the second-layer payment protocol network that indicates channels established between the plurality of user nodes and at least one of balances associated with the plurality of user nodes in the second-layer payment protocol network or balances associated with channels between two or more of the plurality of user nodes, simulating, based on the information obtained about the second-layer payment protocol network, a plurality of transactions between selected user nodes of the plurality of user nodes to obtain transaction simulation results that include at least reliability scores associated with the plurality of user nodes, identifying one or more recommended user nodes based on the transaction simulation results and the information obtained about the second-layer payment protocol network, and providing, to the user, an output indicating the one or more recommended user nodes.

Other embodiments include a non-transitory computer readable storage medium configured to store instructions that, when executed by a processor included in a computing device, cause the computing device to carry out the various steps of any of the foregoing methods. Further embodiments include a channel management system that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The present disclosure will become more fully understood from the detailed description and the accompanying drawings, wherein:

FIG. 1 is an example channel management system for a Lightning Network, according to the present disclosure.

FIG. 2 illustrates steps of an example method for managing transactions over a Lightning Network, according to the present disclosure.

FIG. 3 is an example computing device configured to implement channel management systems and methods, according to the present disclosure.

FIG. 4 is a functional block diagram of an example channel management system for a Lightning Network, according to the present disclosure.

FIG. 5A illustrates example Lightning Network nodes in a Lightning Network, according to the present disclosure.

FIG. 5B illustrates an example adjacency matrix of the Lightning Network of FIG. 5A, according to the present disclosure.

FIG. 5C illustrates the Lightning Network of FIG. 5A with a new LN node, according to the present disclosure.

FIG. 5D illustrates an example adjacency matrix of the Lightning Network of FIG. 5C, according to the present disclosure.

FIG. 6 illustrates steps of an example method for recommending Lightning Network nodes to a user joining a Lightning Network, according to the present disclosure.

In the drawings, reference numbers may be reused to identify similar and/or identical elements.

### DETAILED DESCRIPTION

The present disclosure relates to the fields of cryptocurrency (e.g., Bitcoin) and artificial intelligence/machine learning on second-layer payment protocol networks (e.g., the Lightning Network) to optimize payment reliability. The Lightning Network enables off-chain, peer-to-peer transactions that are faster and cheaper compared to on-chain transactions. Unlike traditional payment rails, however, the Lightning Network has no built-in guarantees for payment reliability, and is prone to payment failure rates significantly higher than traditional payment rails. In that regard, systems and methods of the present disclosure are configured to implement data preprocessing, transaction simulation, and optimization processing (e.g., discrete optimization) to optimize payment reliability as described below in more detail.

For example, data preprocessing includes collecting Lightning Network data, including, but not limited to: node attributes (e.g., node feature flags) and edge attributes (e.g., channel capacity, channel fees, etc.), and preprocessing the collected data to create a graph data structure. In some examples, the graph structure is generated to be suitable for input to a Graph Neural Network (GNN). Additional data regarding channel balances in the network may be collected or obtained through probing (e.g., sending fake payments), voluntary collection, and/or other techniques.

Transaction simulation includes generating and executing a set of synthetic transactions (e.g., in a GNN representation of the Lightning Network). For example, one or more sets of source and destination nodes are selected with corresponding payment amounts for transactions between the source and destination nodes. Initial conditions for channel balances can be sampled from an assumed probability distribution. The simulation executes the transactions, tracks payment successes/failures (i.e., tracks whether any given transaction between a source and destination node succeeds or fails), channel balance changes, collected fees, and so on.

Optimization processing may include various discrete optimization techniques as described below in more detail. From the perspective of a given node, the decision space (i.e., a set of decisions and relationships between decisions with respect to a topological space) includes both (i) a set of potential channels with which to connect, and (ii) fees to set. Therefore, the decision space is extremely large and exhaustive exploration of the decision space within practical computational limits is very difficult. Discrete optimization algorithms (e.g., genetic algorithms, Nelder-Mead algorithms, and so on) according to the present disclosure are configured to explore the topological space (e.g., constrained by number of edges, on-chain fees paid, and so on) to optimize payment reliability. Results of this discrete optimization include channel recommendations that are generated and provided to the end user (e.g., recommendations for which channels to establish in the Lightning Network).

In one example, given an adjacency matrix corresponding to the graph of the Lightning Network, a genetic or other discrete optimization algorithm is applied to a flattened adjacency matrix (e.g., a vectorized adjacency matrix, an unraveled vector of the adjacency matrix, and/or other modified form of the adjacency matrix) to find an optimal solution to maximizing the payment reliability. Constraints can be applied to the genetic algorithm to enforce a number of channels that can be opened (corresponding to, in this example, a number of ones (1s) added to the adjacency matrix). In other examples, other types of discrete optimization algorithms are used, with the same goal of exploring a search space in a more efficient manner.

In some examples, systems and methods of the present disclosure may implement deep learning and/or other machine learning techniques. Deep learning has emerged as a powerful tool in predictive tasks on images and sound. Deep learning systems may use convolutional neural networks (CNNs), recurrent neural networks (RNNs), and subsequent variants based on attention mechanisms (transformers). GNNs are configured to analyze and process graph-structured data. Accordingly, systems and methods according to the present disclosure may implement GNNs for modeling the dynamic nature of the Lightning Network to facilitate optimization of payment reliability. More specifically, the systems and methods of the present disclosure leverage transaction data and known channel balance data that can be obtained either voluntarily or through probing mechanisms. GNNs can learn representations of nodes and edges or channels in a graph, capture their interactions, and make predictions or decisions, including optimizing payment reliability for various channels, based on the learned representations. Combining the Lightning Network with GNNs addresses the challenges associated with payment reliability.

Systems and methods of the present disclosure may include techniques for training the GNN model using preprocessed Lightning Network graph data and a supervised or unsupervised learning approach. The GNN model learns to encode node and edge attributes into low-dimensional representations and captures the dynamic interactions between nodes and edges in the graph. The model learns distributed representations or embeddings of nodes and edges/channels in the network and is trained to predict known channel balances in the Lightning Network. The output of the trained model includes predictions of channel balances across the Lightning Network. If time series information is available, an RNN can additionally or alternatively be used to project the channel balances, as well as a combination of a GNN and RNN to capture both the topological and temporal nature of the interactions. In some examples, as an alternative to a neural network approach, a Lightning Network simulator can also be used to mimic a set of transactions in the network and project channel balances (e.g., probabilistically) across a set of assumptions on transaction distribution and initial conditions on starting channel balances.

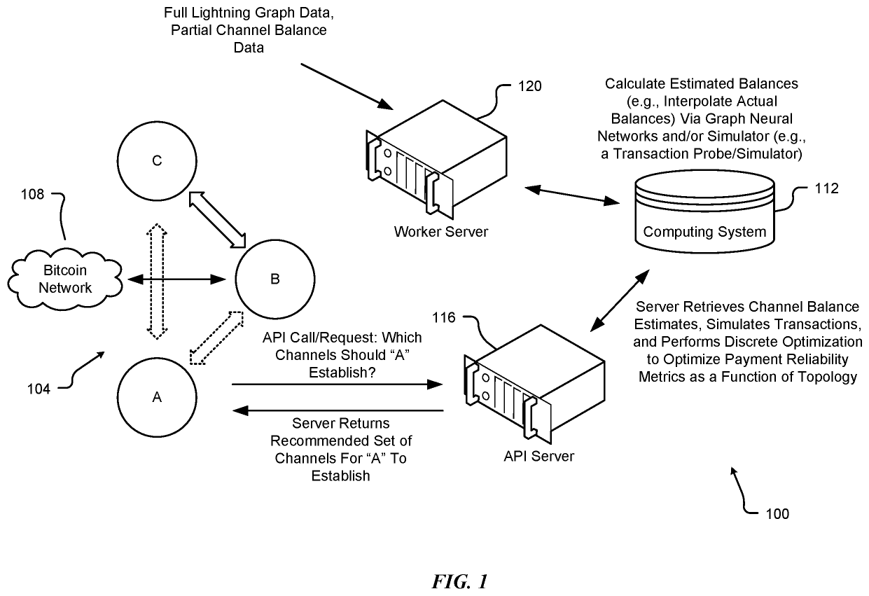

FIG. 1 shows an example channel management system 100, according to the present disclosure. As described herein, the system 100 includes and/or is configured to communicate with a cryptocurrency transaction system, such as a Lightning Network (LN) 104 or other second-layer payment protocol network. The LN 104 enables off-chain, peer-to-peer transactions (i.e., directly between users A, B, C, etc. independent of a Bitcoin network 108). For example, a transaction between users typically requires transmission of a transaction request to the Bitcoin network 108, which verifies and adds the transaction to a Bitcoin blockchain. Such transactions have associated fees and delays. The LN 104 enables transactions directly between users or between chains of users without requiring additional processing (and associated delays) by the Bitcoin network 108. For example, for a typical Bitcoin transaction using the Bitcoin network 108, the transaction is broadcast to the network, mining or processing is performed to add the transaction to a block in the network, other nodes in the network verify the block, and the transaction is then confirmed and can be completed.

The channel management system 100 uses LN data associated with the users and connections between the users to model the LN 104. In some examples, to model the LN 104, the channel management system 100 generates a graph representation of the LN 104. For example, the channel management system 100 uses the LN data as inputs to a GNN (e.g., a GNN implemented by a computing system or device 112 (which may include a database) and/or a server, such as an Application Programming Interface (API) server 116). The GNN models the LN 104 as a graph (e.g., a GNN model) including a set of nodes and edges. The nodes of the graph represent users in the LN 104, while the edges represent connections/channels between respective users. The computing system 112 is configured to train and execute the GNN model (e.g., using deep learning or other ML techniques) to rank or score paths between users in the LN 104, generate a set of one or more recommended channels (and corresponding fees) for a user to connect to, etc., as described below in more detail. As used herein, “users,” “user nodes,” and/or “LN nodes” may refer to nodes of the LN 104, while “GNN nodes” refers to nodes represented graphically in the GNN.

As one example, the channel management system 100 (e.g., the computing system 112) receives available LN data (e.g., as a snapshot, via a worker server 120) and constructs the GNN model based on the received LN data. The available LN data may include, for example, data associated with respective LN nodes, such as a node identifier, a balance of the node (i.e., an amount of Bitcoin the associated user has available to spend), a capacity of the node, a time that the information of the LN node was last updated, and a list of features the LN node supports. The capacity of the LN node corresponds to a total amount of Bitcoin available to the user, including Bitcoin held in channels/connections with other LN nodes. Accordingly, the capacity of the LN node is indicative of an amount of Bitcoin that can be routed through that LN node and depends upon the number of channels between the LN node and other LN nodes (and the capacity/balances of those LN nodes).

The LN data received from the LN 104 (i.e., corresponding to data that is actually available) may be limited. For example, data of only some of the LN nodes may be available. Data such as balances, capacities, etc., may not be available for all of the LN nodes. Accordingly, the LN data actually received from the LN 104 by the channel management system 100 may be referred to as limited or partial LN data. The channel management system 100 according to the present disclosure is configured to train and execute the GNN using inputs based on only the partial data available from the LN 104. For example, the channel management system 100 is configured to calculate estimated or predicted balances for each of the LN nodes (represented in the GNN as GNN nodes) based on the partial data, transaction data (including successful and unsuccessful transactions between users via the LN 104), probing data, etc., and generate edges between the GNN nodes.

Conversely, the edges may correspond to one or more vectors (e.g., bi-directional vectors corresponding to possible transactions in both directions) between adjacent LN nodes. As one example, each vector may indicate a predicted balance/distribution across the adjacent LN nodes. For example, for any given pair of adjacent LN nodes, an overall balance (and therefore amount available for a transaction passing through the LN nodes) may not be equally distributed between the LN nodes. An unequal distribution of the overall balance (e.g., 90% or more attributed to one LN node with 10% or less attributed to the other LN node) may indicate that a transaction routed through a corresponding pair of LN nodes may have less of a likelihood of being successful than a transaction routed through a pair of LN nodes having a more equal distribution (e.g., each of the LN nodes having 50% of the overall balance of the pair of LN nodes). Accordingly, the edges of the GNN according to the present disclosure do not simply represent the presence of an existing channel or connection between two LN nodes, but instead additionally indicate a balance distribution between the two LN nodes. In other words, outputs of the GNN include channel balance estimates that indicate channel balance relationships between LN nodes.

In an example, while some data may be obtained voluntarily, the channel management system 100 may determine or estimate other data using various probing mechanisms. For example, the channel management system 100 may be configured to execute or generate fake (e.g., mock or simulated) payment requests. Success or failure of such requests may be indicative of LN node and channel balances. For example, a successful payment request indicates that a particular LN node and/or channel has sufficient funds to fulfill the request, while a failed payment indicates that the LN node and/or channel does not have sufficient funds to fulfill the request. In this manner, multiple requests for different values will provide information indicative of minimum and maximum transactions that can be completed by a particular LN node or along a particular path between LN nodes.

In another example, the channel management system 100 may incorporate (e.g., in each vector) balance changes over time. For example, LN node and channel balances may have a sinusoidal or other variable pattern that may be represented using time-series data, a time-series model, and so on. Accordingly, the channel balance estimates may be further calculated based on the flow of balances over time.

The channel management system 100 receives information associated with a request from a user (e.g., user A) to join the LN 104 as a new node and to establish one or more channels with existing users in the LN 104 (e.g., via an API call/request routed through and processed by the API server 116). For example, the information may include, but is not limited to, an identifier associated with the user, a number of LN nodes with which to establish channels (e.g., a single value or a range of values), a balance of the new node (e.g., an amount of Bitcoin available to the user), a list of features the new node will support, one or more desired transaction amounts associated with the new node (e.g., a maximum transaction amount, a range of transaction amounts, and so on), one or more fees associated with transactions conducted by the new node (e.g., a minimum fee, a maximum fee, a range of fees, and so on), and a desired capacity of the new node. The capacity of the new node corresponds to a total amount of Bitcoin available to the user, including Bitcoin held in channels/connections with other LN nodes. Accordingly, the capacity of the new node is indicative of an amount of Bitcoin that can be routed through that new node and depends upon the number of channels between the new node and other LN nodes, the capacities/balances of the LN nodes, and so on.

According to some embodiments, the channel management system 100 (e.g., the API server 116, the computing system 112, or a combination thereof) retrieves and analyzes the channel balance estimates and other outputs (e.g., other information contained in the vectors) from the GNN, simulates transactions between various sets of the LN nodes based on the retrieved channel balance estimates, and performs discrete optimization to optimize payment reliability based on results of the simulated transactions as described below in more detail. For example, the results of the simulated transactions may correspond to reliability scores (e.g., reliability scores indicative of a percentage of simulated transactions that were successful for a given range of transaction amounts). The reliability scores may be assigned to each channel and/or to each LN node. To perform discrete optimization, the channel management system 100 executes one or more discrete optimization algorithms (e.g., using the reliability scores) to identify, for the new node, one or more recommended LN nodes with which to establish channels/connections.

In some examples, the simulated transactions and the discrete optimization include calculations of collected fees for the transactions. For example, the results of the simulated transactions, in addition to the reliability scores, include collected fee scores for each transaction. Accordingly, the one or more recommended LN nodes may be identified based on the reliability scores, collected fee scores, and/or combinations thereof. In this manner, the recommended LN nodes are selected to maximize both reliability and collected fees.

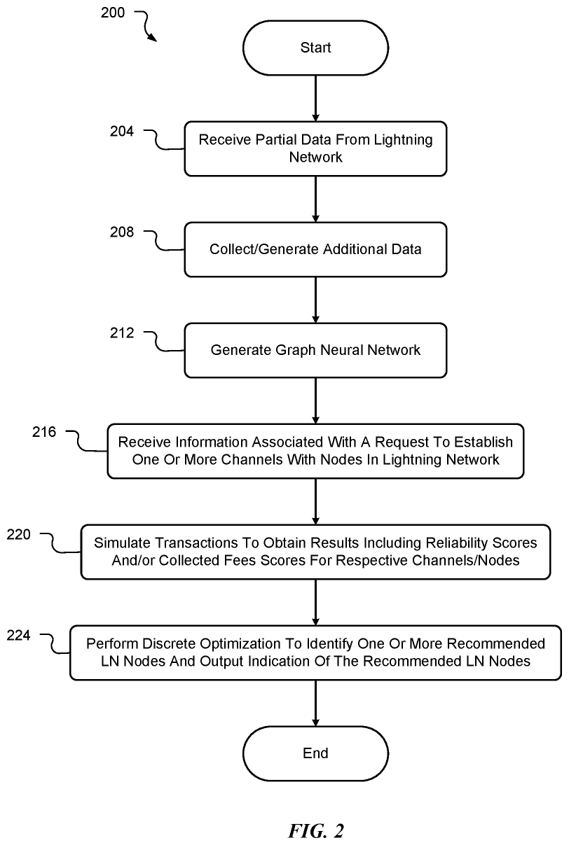

FIG. 2 illustrates steps of an example method 200 for managing channels of a Lightning Network, including identifying one or more LN nodes with which to establish channels, according to the present disclosure. For example, the method 200 may be executed by one or more components, individually or collectively, of the channel management system 100. At 204, the channel management system 100 receives available (e.g., partial) LN data from the LN 104 (and/or from other sources). The received data may include, but is not limited to, data associated with respective LN nodes and channels. At 208, channel management system 100 obtains (e.g., collects and/or generates) additional data indicative of channel balances of the LN 104. For example, the additional data may include, but is not limited to, data interpolated from the partial data, data obtained using probing techniques as described herein, time-series data (e.g., using previously obtained/generated data stored in the worker server 120, the computing system 112, etc.), and other suitable data.

At 212, the channel management system 100 generates a GNN based on the partial data and the additional data. The GNN includes GNN nodes that correspond to respective LN nodes, and edges that correspond to connections/channels between the LN nodes, as described herein. The edges may also include vectors, as described herein. For example, the vectors may include at least channel balance estimates and balance distributions.

At 216, the channel management system 100 receives information associated with a request for a user to join the LN 104 as a new node. At 220, the channel management system 100 simulates transactions between various sets of the LN nodes to obtain simulated transaction results. For example, the results may include various reliability scores and/or collected fees scores for each channel and/or LN node. At 224, the channel management system 100 performs discrete optimization to identify one or more recommended LN nodes with which to establish channels/connections when joining the LN 104, and generates and outputs an indication of the recommended nodes.

Accordingly, methods according to the present disclosure optimize channel management to facilitate selection of LN nodes when joining the LN 104. Although described with respect to the Bitcoin network and an associated Lightning Network, the principles of the present disclosure may be implemented in other types of second-layer payment protocol networks and cryptocurrency networks.

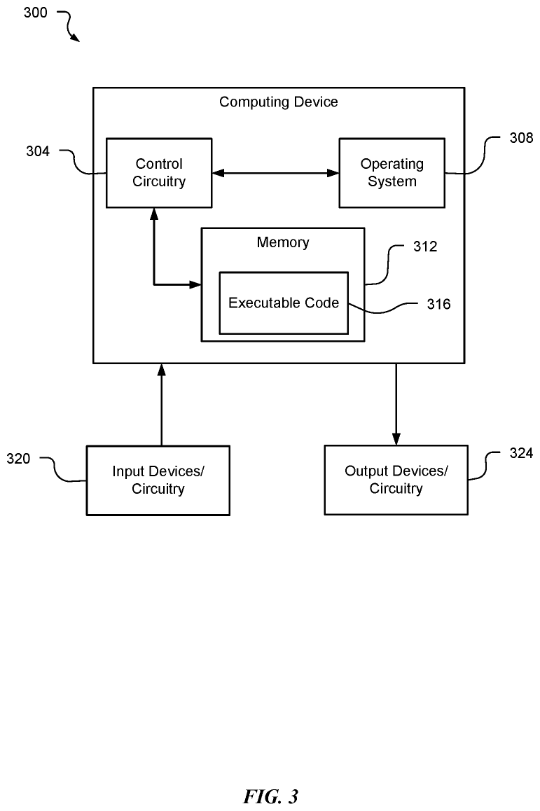

FIG. 3 shows a block diagram of an example computing device 300 configured to implement functions of the systems and methods described herein, according to the present disclosure. For example, the computing device 300 may implement or be implemented by the one or more components of the channel management system 100, including, but not limited to, the computing system 112, the servers 116/120, etc., respectively, or collectively. Systems described herein may implement a single computing device, a plurality of computing devices, etc., configured to individually and/or collectively perform functions related to the systems and methods of the present disclosure.

The computing device 300 may include control circuitry 304 that may be, for example, one or more processors or processing devices, a central processing unit processor (CPU), an integrated circuit or any suitable computing or computational device, an operating system 308, a memory 312, executable code 316, input devices or circuitry 320, and output devices or circuitry 324. The control circuitry 304 (or one or more controllers or processors, possibly across multiple units or devices) may be configured to implement functions of the systems and methods described herein. More than one of the computing devices 300 may be included in, and one or more of the computing devices 300 may act as the components of, a system according to embodiments of the disclosure. Various components of the computing device 300 may be implemented with same or different circuitry, same or different processors or processing devices, etc.

The operating system 308 may be or may include any code segment (e.g., one similar to the executable code 316 described herein) designed and/or configured to perform tasks involving coordination, scheduling, arbitration, supervising, controlling or otherwise managing operation of the control circuitry 304 (e.g., scheduling execution of software programs or tasks or enabling software programs or other hardware modules or units to communicate). The operating system 308 may be a commercial operating system. The operating system 308 may be an optional component (e.g., in some embodiments, a system may include a computing device that does not require or include the operating system 308). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 312 may be or may include, for example, Random Access Memory (RAM), read only memory (ROM), Dynamic RAM (DRAM), Synchronous DRAM (SD-RAM), a double data rate (DDR) memory chip, Flash memory, volatile memory, non-volatile memory, cache memory, a buffer, a short-term memory unit, a long-term memory unit, or other suitable memory units or storage units. The memory 312 may be or may include a plurality of memory units, which may correspond to same or different types of memory or memory circuitry. The memory 312 may be a computer or processor non-transitory readable medium, or a computer non-transitory storage medium, e.g., RAM.

The executable code 316 may be any executable code, e.g., an application, a program, a process, task, or script. The executable code 316 may be executed by the control circuitry 304, possibly under control of the operating system 308. Although, for the sake of clarity, a single item of the executable code 316 is shown, a system according to some embodiments of the disclosure may include a plurality of executable code segments similar to the executable code 316 that may be loaded into the memory 312 and cause the control circuitry 304 to carry out methods described herein. Where applicable, the terms “process” and “executable code” may be used interchangeably herein. For example, verification, validation and/or authentication of a process may mean verification, validation and/or authentication of executable code.

In some examples, the memory 312 may include non-volatile memory having the storage capacity of a storage system. In other examples, the computing device 300 may include or communicate with a storage system and/or database. Such a storage system may include, for example, flash memory, memory that is internal to, or embedded in, a micro controller or chip, a hard disk drive, a solid-state drive, a CD-Recordable (CD-R) drive, a Blu-ray disk (BD), a universal serial bus (USB) device or other suitable removable and/or fixed storage unit. Content may be stored in the storage system and loaded from the storage system into the memory 312 where it may be processed by the control circuitry 304.

The input circuitry 320 may be or may include any suitable input devices, components, or systems, e.g., physical sensors such as accelerometers, thermometers, microphones, analog to digital converters, etc., a detachable keyboard or keypad, a mouse, etc. The output circuitry 740 may include one or more (possibly detachable) displays or monitors, motors, servo motors, speakers and/or any other suitable output devices. Any applicable input/output (I/O) devices may be connected to the control circuitry 304. For example, a wired or wireless network interface card (NIC), a universal serial bus (USB) device, or external storage device may be included in the input circuitry 320 and/or the output circuitry 324. It will be recognized that any suitable number of input devices and output devices may be operatively connected to the control circuitry 304. For example, the input circuitry 320 and the output circuitry 324 may be used by a technician or engineer in order to connect to the control circuitry 304, update software, and the like.

Embodiments may include an article such as a computer or processor non-transitory readable medium, or a computer or processor non-transitory storage medium, such as for example memory, a disk drive, or USB flash memory, encoding, including or storing instructions (e.g., computer-executable instructions, which, when executed by a processor or controller, carry out methods disclosed herein), a storage medium such as the memory 312, computer-executable instructions such as the executable code 316, and a controller such as the control circuitry 304.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the disclosure may include components such as, but not limited to, a plurality of central processing units (CPU) or any other suitable multi-purpose or specific processors or controllers (e.g., controllers similar to the control circuitry 304), a plurality of input units, a plurality of output units, a plurality of memory units, and a plurality of storage units, etc. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on-board system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the control circuitry 304.

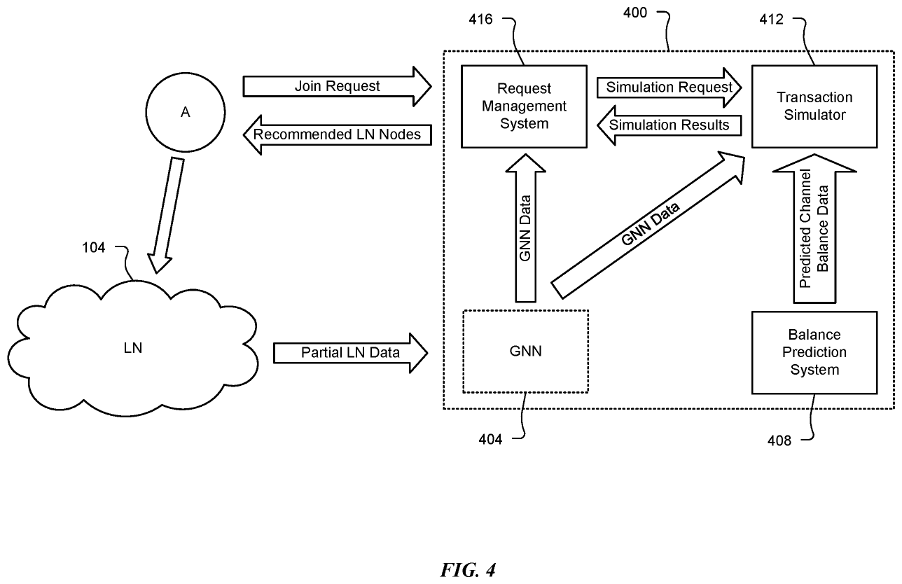

FIG. 4 shows a functional block diagram of an example channel management system 400, according to the present disclosure. For example, the channel management system 400 may correspond to the channel management system 100 of FIG. 1, and may include the same or similar components (shown schematically) as the channel management system 100. The channel management system 400 is configured to implement functions of the present disclosure described above in FIGS. 1-3, and further described below in more detail, including, but not limited to, communicating with the LN 104 to receive partial data, and applying a GNN 404 to the LN 104, predicting additional data (e.g., predicted channel balance data) based on the GNN 404 (e.g., based on GNN data describing the GNN 404), simulating transactions based on the predicted channel balance data, and performing discrete optimization to identify recommended LN nodes with which to establish channels. All or portions of the channel management system 400 may be implemented by a computing device, such as the computing device 300 described above in FIG. 3, one or more of computing devices configured to individually and/or collectively perform the functions (e.g., using one or more processors as defined herein), and so on. When implemented by more than one computing device, the computing devices may be located in a single location or multiple locations (e.g., implemented using a cloud computing system, using one or more connected servers, using a distributed communication system such as the Internet, and so on).

For example, the channel management system 400 receives partial LN data from the LN 104, which may be received by or other otherwise input to the GNN 404. The GNN 404 is configured to generate at least one graphical representation of the partial LN data. In an embodiment, the partial LN data includes data identifying the LN nodes of the LN 104, relationships (e.g., established channels) between the LN nodes of the LN 104, and channel capacity/balance. A channel capacity between two LN nodes may be an estimate of an overall channel capacity representing a total of individual channel capacities in either direction between the nodes. For example, while the overall channel capacity between two LN nodes may be estimated to be 350,000 (e.g., dollars or other units), actual individual channel capacities are unknown. Accordingly, the GNN 404 includes a graph representing the LN 104 as GNN nodes, and representing channels between the LN nodes as edges. Initially, the edges may only be assigned respective overall channel capacities.

In some examples, the channel management system 400 includes a balance prediction system 408 configured to calculate the individual channel capacities (e.g., predicted channel balance data) based on data contained in the generated graph (e.g., based on GNN data output by the GNN 404). The predicted channel balance data may correspond to the additional data described above, such as the additional data obtained at 208 of the method 200 of FIG. 2. The balance prediction system 408 may generate the predicted channel balance data by interpolating the partial LN data (e.g., interpolating the overall channel capacities contained in the graph), performing various probing techniques on the LN 104 as described above, analyzing time-series data, and so on. In some examples, the balance prediction system 408 provides the predicted channel balance data to the GNN 404, which updates the graph based on the predicted channel balance data. In other examples, the balance prediction system 408 provides the predicted channel balance data directly to a transaction simulator 412.

A request management system 416 is configured to receive requests, such as a join request from a user A (e.g., directly from the user A, from the LN 104, etc.), to join the LN 104 as a new node (and/or as an existing node in the LN 104), to establish new channels within the LN 104. For example, the join request may include information associated with the join request such as an identifier associated with the user, a number N (an integer greater than or equal to one) of LN nodes with which to establish channels, a balance of the new node, a list of features the new node will support, one or more desired transaction amounts associated with the new node, one or more fees associated with transactions conducted by the new node, a desired capacity of the new node, and so on.

For example, the user A submits the request at a user interface, such as a computing device (e.g., the computing device 300) implementing an application configured to facilitate interaction with the LN 104. In one example, the computing device is a mobile device, smartphone, laptop or desktop computer, tablet computer, etc. of the user A implementing one or more LN applications or other cryptocurrency applications. The computing device may include one or more input devices, such as a touchscreen interface, that allow the user A to provide inputs that indicate parameters of the join request.

The transaction simulator 412 is configured to simulate transactions between various sets of the LN nodes in the LN 104. As used herein, “simulated transactions” correspond to fake, synthetic, etc. transaction requests generated by the transaction simulator 412 to assess the reliability of transactions conducted between LN nodes in the LN 104. Simulating transactions may include executing a set of simulated transactions (e.g., in the GNN 404 and/or based on GNN data received from the GNN, predicted channel balance data received from the balance prediction system 408, and so on). For example, one or more sets of source and destination nodes are selected with corresponding payment amounts for transactions between the source and destination nodes. Initial conditions for channel balances can be sampled from an assumed probability distribution in accordance with the GNN data and/or the predicted channel balance data. In some examples, the transaction simulator 412 may simulate the same transactions for each node or pair of nodes, such as a predetermined set of transactions of varying amounts. In other examples, the simulated transactions may be randomized for each LN node or pair of LN nodes.

In some examples, the transaction simulator 412 automatically simulates transactions to obtain simulated transaction results periodically (e.g., hourly, daily, etc.) and tracks payment successes/failures and collected fees during each simulated transaction. Accordingly, the transaction results may include, but are not limited to, a reliability score and a collected fees score for each node. As one example, the reliability score is a success (or failure) rate, such as a percentage of transactions that were executed successfully (or failed). As another example, the reliability score includes a plurality of success rates for respective ranges or tiers of transaction amounts (e.g., a first score or percentage for transactions within a first range of values, a second score or percentage for transactions within a second range of values greater than the first range of values, and so on). Conversely, the collected fees score may include the total fees earned (e.g., a total amount of bitcoin) for a predetermined number of transactions, an average number of LN nodes used per transaction, and so on.

In some examples, the transaction simulator 412 the transaction results correspond to a most recent transaction simulation (i.e., a current reliability score). In other examples, the transaction simulator 412 maintains running transaction results (i.e., reliability scores and collected fees scores) for a predetermined period. For example, the transaction results may correspond to transaction simulations executed within the previous hour, day, week, and so on. In other words, the scores may correspond to average scores over the predetermined period. In some examples, the transaction results may include a plurality of scores, for each LN node, for respective predetermined periods (e.g., a current reliability score, a reliability score for the previous hour, a reliability score for the previous day, and so on).

Alternatively, or additionally, in other examples the transaction simulator 412 may simulate transactions in response to receiving a simulation request from the request management system 416 (e.g., a simulation request triggered in response to the request management system 416 receiving a join request from the user A to establish channels with one or more existing LN nodes in the LN 104). In these examples, the simulation request may include all or portions of the information contained in the join request. Accordingly, the transaction simulator 412 may be configured to simulate transactions based on the information contained in the join request, such as desired transaction amounts associated with the new node. For example, the transaction simulator 412 may simulate transactions only for LN nodes having a minimum balance, for a predetermined range of transaction amounts, for transaction amounts greater than or equal to a minimum transaction amount, and so on.

In some examples, the transaction simulator 412 may be configured to simulate transactions based on one or more other criteria. For example, the transaction space for the LN 104 (and, correspondingly, the GNN 404) is typically extremely large. Accordingly, simulating transactions for every LN node may not be feasible. In this regard, the transaction simulator 412 may be configured to simulate transactions for only a subset of the entire LN 104, such as only for LN nodes that meet the one or more criteria. The criteria may include, but are not limited to, a minimum channel balance of the LN node, a minimum number of channels established with other LN nodes, minimum or maximum fees associated with the LN node, and/or minimum reliability scores obtained for the LN node in previous simulated transactions.

The request management system 416 communicates with the GNN 404 to receive the GNN data (and, in some examples, with the balance prediction system 408 to receive the predicted channel balance data), and receives the simulation results from the transaction simulator 412. The request management system 416 is configured to, based on GNN data and the simulation results, identify and select one or more LN nodes (e.g., in accordance with the number N of LN nodes indicated in the join request) with which to connect/establish channels. The request management system 416 generates and outputs data (e.g., to the user A) indicating recommended LN nodes based on the selected one or more LN nodes. For example, the recommended LN nodes are provided/output to a computing device of the user A (e.g., via an application implemented by the computing device).

In some examples, the request management system 416 may select the number N LN nodes based on the reliability scores (and, in some examples, further based on the collected fees scores) contained within the simulation results. In one example, the request management system 416 may simply select N LN nodes having the highest reliability scores. In another example, the request management system 416 may select, from among LN nodes having a collected fees score above a fees threshold, N LN nodes having the highest reliability score. In another example, the request management system may select N LN nodes having the highest collected fees score from among LN nodes also having a reliability score above a reliability threshold. In still another example, the request management system 416 may be configured to apply respective weights to the reliability scores and collected fees scores (e.g., based on weight information contained in the join request) and select NLN nodes based on a weighted combination of the reliability score and the collected fees score. In other words, the request management system 416 may be configured to select the N LN nodes by various combinations of the reliability scores and the collected fees scores.

In some examples, the request management system 416 may be configured to apply different criteria for selecting two or more different LN nodes. For example, the request management system 416 may select one or more of the N LN nodes having the highest reliability scores, while selecting others of the N LN nodes having the highest collected fees scores. In this manner, the recommended LN nodes may provide more diverse and robust transaction capabilities.

In other examples, the request management system 416 is configured to, based on the GNN data and the simulation results, perform optimization techniques to identify and select the N LN nodes. Optimization may include various discrete optimization techniques, such as discrete optimization algorithms, genetic algorithms, and so on. From the perspective of a given LN node (i.e., a potential LN node with which to establish a channel/connection), the decision space is considerably large and requires consideration of both (i) a set of potential channels/LN nodes with which to connect, and (ii) fees to set for transactions. In other words, there is a considerably large number of potential LN nodes with which to connect. The request management system 416 is configured to apply one or more discrete optimization techniques to the GNN data and the simulation results to select LN nodes that optimize payment reliability.

In one example, the request management system 416 is configured to, based on the GNN data, generate an adjacency matrix corresponding to the GNN 404 of the LN 104. In other words, the request management system 416 constructs an adjacency matrix representing LN nodes and connections between the LN nodes in the LN 104. An adjacency matrix is a, typically, square matrix representing a finite space or graph. The adjacency matrix is comprised of elements each representing a connection (i.e., adjacency) between vertices (i.e., in this example, LN nodes in the LN 104).

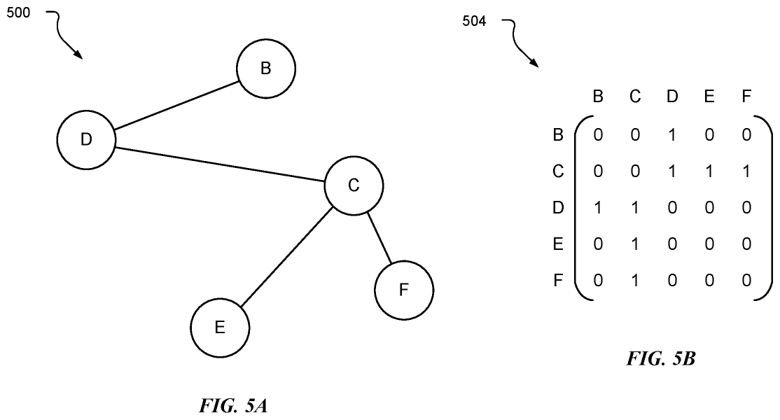

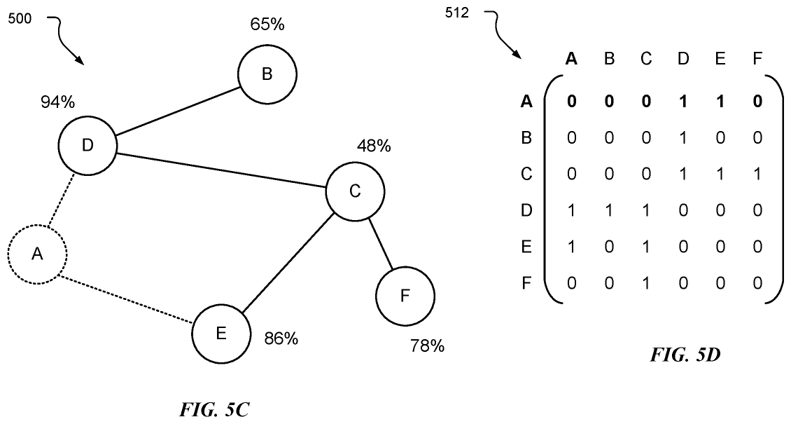

FIG. 5A shows a graphical representation of an example LN 500, and FIG. 5B shows an example adjacency matrix 504 representing the LN 500. The LN 500 may correspond to all or only a portion of an entire LN. In this example, the LN 500 includes five LN nodes B, C, D, E, and F. As shown: LN node B is directly coupled to LN node D; LN node C is directly coupled to LN nodes D, E, and F; LN node D is directly coupled to LN nodes B and C; LN node E is directly coupled to LN node C; and LN node F is directly coupled to LN node C.

Each element in the adjacency matrix 504 indicates whether there is a connection (i.e., edge) between LN nodes (i.e., vertices). For example, a zero (0) indicates that there is no connection between two LN nodes, and a one (1) indicates that there is a connection between two LN nodes (i.e., at an intersection between corresponding rows and columns). Accordingly, a row B corresponding to the LN node B is 0, 0, 1, 0, 0, indicating connections with LN node D. In other words, the 1 in row B is in a position corresponding to an intersection with a column labeled D. Rows C, D, E, and F indicate respective connections to the LN nodes in the LN 500 in a similar manner.

FIG. 5C shows a graphical representation of an example connection of a new user (corresponding to LN node A) to the LN 500, and FIG. 5B shows an example adjacency matrix 512 representing the LN 500 including the new user A. In this example, the LN node A is connected to LN nodes D and E. Accordingly, a row A corresponding to the LN node A is 0, 0, 0, 1, 1, 0.

As shown in FIG. 5C, each of the LN nodes may have an associated reliability score. For example, the reliability scores may correspond to simulation results received, by the request management system 416, from the transaction simulator 412. In some examples, the request management system 416 provides a recommendation that the user A connect to the LN nodes D and E since the LN nodes D and E have the highest reliability scores from among the LN nodes B, C, D, and E.

However, due to the considerably large decision space for a typical LN (i.e., an LN having a significantly greater number of LN nodes, such as tens of thousands of LN nodes), direct comparisons and assessments of payment reliability for all of the LN nodes and possible transaction paths is not practical. Accordingly, the request management system 416 is configured to perform additional processing using the one or more adjacency matrices (e.g., the adjacency matrix 504 without the new LN node, one or more adjacency matrices with the new LN node A connected to one or more of the LN nodes, and so on) to optimize payment reliability.

In an example, the request management system 416 is configured to construct, based on the adjacency matrix of the LN without the new LN node (e.g., the LN node A as shown in FIG. 5C), a plurality of adjacency matrices with an additional row corresponding to the new LN node. For example, for an M×M adjacency matrix (where M is potentially extremely large, e.g., greater than 1000), the request management system 416 constructs a plurality of P×P matrices, each having an additional row and column, relative to the M×M matrix, corresponding to the new LN node. In other words, P=M+1. The M×M adjacency matrix may correspond to all or only a subset of the LN.

In each of the constructed P×P matrices, the row corresponding to the new LN node indicates connections with N (e.g., two) of the existing LN nodes in the LN, where N is a number of desired connections indicated in the join request. In another example, the row corresponding to the new LN nodes indicates connections to less than N of the existing LN nodes. For example, for N=2, the request management system 416 may be configured to select a first LN node with which to connect, and then select a second LN node with which to connect at least partially based on the selected first LN node. In this example, the request management system 416 may be configured to select a second LN node that has no connections to the first LN node, that has connections to other LN nodes in the LN that the first LN node does not have connections to, and so on. In other examples, for each P×P matrix, the connections to the N existing LN nodes may be selected randomly.

The request management system 416 applies a reliability optimization algorithm (e.g., a discrete optimization algorithm, a genetic algorithm, etc.) to each P×P matrix. The reliability optimization algorithm includes, as inputs, both the P×P adjacency matrix (i.e., indicating connections between existing LN nodes in the LN and N connections between the new LN node and N existing LN nodes), and the simulation results (e.g., the reliability scores and/or the collected fees scores). Accordingly, the request management system 416 is configured to, for each P×P matrix, assess reliability for connections to specific existing LN nodes based on both connections between existing LN nodes, and payment reliability of the existing LN nodes.

In one example, the request management system 416 constructs a flattened or vectorized adjacency matrix, such as by constructing an unraveled vector of the M×M matrix, and provides the unraveled vector and the simulation results as inputs to the reliability optimization algorithm (e.g., a genetic algorithm). The unraveled vector is a vector having a length of M squared and includes all of the elements in the M×M matrix (e.g., a one-dimensional array that includes, sequentially, all of the elements of each of the rows of the M×M matrix). The genetic algorithm is configured to calculate and output, based on the unraveled vector and the simulation results, an optimal solution to maximizing the payment reliability. For example, the genetic algorithm constructs a P×P matrix that maximizes payment reliability. In an example, the output of the genetic algorithm indicates N recommended LN nodes. Various constraints may be applied to the genetic algorithm based on the join request, such as the number N of channels/connections to be established with existing LN nodes, criteria associated with reliability scores, and/or collected fees scores as described above, and so on.

For example, for an input of an M×M matrix and constraints such as a number N of channels to establish with existing LN nodes, the genetic algorithm may be configured to output a P×P matrix that maximizes a given function or goal (e.g., an objective function). In this example, the objective function corresponds to a maximized payment reliability of the new LN node. The maximized payment reliability may correspond to connections to N LN nodes having the highest reliability scores, N LN nodes having the highest reliability scores and with collected fees scores above a threshold, N LN nodes having the highest collected fees scores and with reliability scores above a threshold, and so on, as described herein. In one example, collected fees criteria are provided as additional constraints for the genetic algorithm. In other examples, other types of metaheuristic and discrete optimization algorithms may be used.

While described herein with respect to connections between a new LN node and existing LN nodes, the principles of the present disclosure may also be implemented for establishing new channels for an existing LN node, rearranging channels for an existing LN node (e.g., terminating one or more channels and adding one or more new channels), and so on.

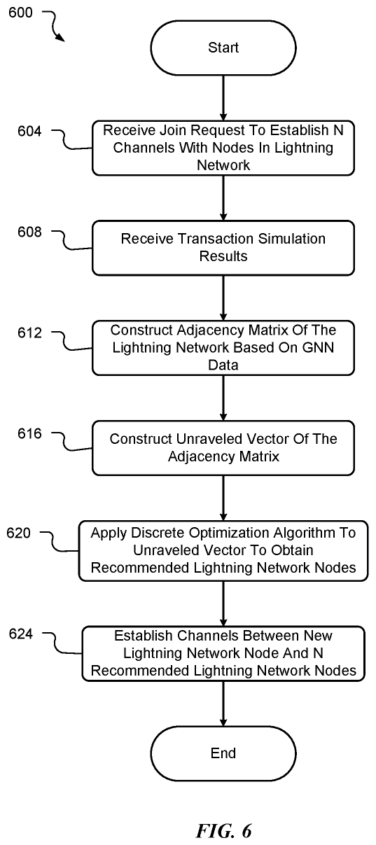

FIG. 6 illustrates steps of an example method 600 for identifying, selecting, and recommending, to a user, LN nodes with which to establish channels, according to the present disclosure. For example, the method 600 may be executed by one or more components, individually or collectively, of the channel management system 400.

At 604, the channel management system 400 (e.g., at a computing device configured to implement the request management system 416,) includes the step of receiving a join request. The join request corresponds to a request from a user to join the LN as a new node (or, from an existing user to establish one or more new channels). The join request includes information such as at least an identifier associated with the user, and a number N of LN nodes with which to establish channels. The join request may also include additional criteria, such as collected fees criteria as described herein. In an example, the join request is received from a computing device of the user. The join request may be generated in response to inputs, provided by the user, at an LN application or other cryptocurrency application implemented by the computing device.

At 608, the channel management system 400 (e.g., the request management system 416) includes the step of receiving transaction simulation results (e.g., from the transaction simulator 412). The transaction results correspond to transactions simulated between various sets of the LN nodes to obtain the simulated transaction results. For example, the transaction results may include various reliability scores and/or collected fees scores for each channel and/or LN node.

At 612, the channel management system 400 (e.g., the request management system 416) includes the step of constructing an adjacency matrix of the LN. For example, the adjacency matrix is constructed based on GNN data corresponding to the LN. The adjacency matrix indicates connections between LN nodes of the LN.

At 616, the channel management system 400 (e.g., the request management system 416) optionally includes the step of constructing an unraveled vector of the adjacency matrix. For example, for an M×M adjacency matrix, the unraveled vector is a one-dimensional array having a length of M squared.

At 620, the channel management system 400 (e.g., the request management system 416) includes the step of applying a discrete optimization algorithm (e.g., a genetic algorithm) to the unraveled vector to obtain and output N recommended LN nodes. Applying the discrete optimization algorithm may include providing, as inputs to the discrete optimization algorithm, the unraveled vector and one or more constraints such as the number N of LN nodes, reliability scores contained in the simulated transaction results, and so on. The discrete optimization algorithm may output a solution such as a P×P adjacency matrix (where P=M+1) that (i) represents connections between a new LN node and existing LN nodes, and (ii) maximizes payment reliability for the new LN node. In an example, the N recommended LN nodes are provided to the user at the computing device of the user.

At 624, the channel management system 400 includes the step of establishing channels between the new LN node (i.e., the new LN node corresponding to the new user) and the N LN nodes recommended by the request management system 416.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A method for managing channels, the method comprising, by a computing device:
receiving a join request from a user, wherein the join request corresponds to a request to establish one or more channels with respective user nodes of a plurality of user nodes in a second-layer payment protocol network configured to process transactions between users associated with a cryptocurrency network;
obtaining information about the second-layer payment protocol network, wherein the information indicates channels established between the plurality of user nodes and at least one of (i) balances associated with the plurality of user nodes in the second-layer payment protocol network or (ii) balances associated with channels between two or more of the plurality of user nodes;
simulating, based on the information obtained about the second-layer payment protocol network, a plurality of transactions between selected user nodes of the plurality of user nodes to obtain transaction simulation results, wherein the transaction simulation results include at least reliability scores associated with the plurality of user nodes;
identifying one or more recommended user nodes based on the transaction simulation results and the information obtained about the second-layer payment protocol network; and
providing, to the user, an output indicating the one or more recommended user nodes.

2. The method of claim 1, wherein the transaction simulation results further include collected fees scores associated with the plurality of user nodes.

3. The method of claim 1, wherein identifying the one or more recommended user nodes includes performing discrete optimization on the information obtained about the second-layer payment protocol network.

4. The method of claim 1, wherein identifying the one or more recommended user nodes includes (i) constructing, based on the information obtained about the second-layer payment protocol network, an adjacency matrix of the second-layer payment protocol network, and (ii) applying a discrete optimization algorithm to the adjacency matrix to identify the one or more recommended user nodes.

5. The method of claim 4, further comprising (i) constructing an unraveled vector of the adjacency matrix and (ii) providing, as inputs to the discrete optimization algorithm, the unraveled vector, the transaction simulation results, and a number of respective user nodes indicated by the join request.

6. The method of claim 5, wherein the discrete optimization algorithm is at least one of a genetic algorithm and a Nelder-Mead algorithm.

7. The method of claim 1, further comprising (i) generating, based on the information obtained about the second-layer payment protocol network, a graph neural network (GNN) and (ii) simulating the plurality of transactions based on the GNN.

8. The method of claim 7, further comprising:
constructing, based on the GNN, an adjacency matrix of the second-layer payment protocol network; and
applying a discrete optimization algorithm to the adjacency matrix to identify the one or more recommended user nodes.

9. The method of claim 1, wherein the second-layer payment protocol network comprises the Lightning Network, and wherein the cryptocurrency network comprises the Bitcoin network.

10. A channel management system, comprising:
a computing device configured to:
receive a join request from a user, wherein the join request corresponds to a request to establish one or more channels with respective user nodes of a plurality of user nodes in a second-layer payment protocol network configured to process transactions between users associated with a cryptocurrency network;
obtain information about the second-layer payment protocol network, wherein the information indicates channels established between the plurality of user nodes and at least one of (i) balances associated with the plurality of user nodes in the second-layer payment protocol network or (ii) balances associated with channels between two or more of the plurality of user nodes;
simulate, based on the information obtained about the second-layer payment protocol network, a plurality of transactions between selected user nodes of the plurality of user nodes to obtain transaction simulation results, wherein the transaction simulation results include at least reliability scores associated with the plurality of user nodes;
identify one or more recommended user nodes based on the transaction simulation results and the information obtained about the second-layer payment protocol network; and
provide, to the user, an output indicating the one or more recommended user nodes.

11. The channel management system of claim 10, wherein the transaction simulation results further include collected fees scores associated with the plurality of user nodes.

12. The channel management system of claim 10, wherein, to identify the one or more recommended user nodes, the computing device is configured to perform discrete optimization on the information obtained about the second-layer payment protocol network.

13. The channel management system of claim 10, wherein, to identify the one or more recommended user nodes includes, the computing device is configured to (i) construct, based on the information obtained about the second-layer payment protocol network, an adjacency matrix of the second-layer payment protocol network, and (ii) applying a discrete optimization algorithm to the adjacency matrix to identify the one or more recommended user nodes.

14. The channel management system of claim 13, wherein the computing device is further configured to (i) construct an unraveled vector of the adjacency matrix and (ii) provide, as inputs to the discrete optimization algorithm, the unraveled vector, the transaction simulation results, and a number of the respective user nodes indicated by the join request.

15. The channel management system of claim 14, wherein the discrete optimization algorithm includes at least one of a genetic algorithm and a Nelder-Mead algorithm.

16. The channel management system of claim 10, wherein the computing device is further configured to (i) generate, based on the information obtained about the second-layer payment protocol network, a graph neural network (GNN) and (ii) simulate the plurality of transactions based on the GNN.

17. The channel management system of claim 16, wherein the computing device is further configured to:
construct, based on the GNN, an adjacency matrix of the second-layer payment protocol network; and
apply a discrete optimization algorithm to the adjacency matrix to identify the one or more recommended user nodes.

18. The channel management system of claim 10, wherein the second-layer payment protocol network comprises the Lightning Network, and wherein the cryptocurrency network comprises the Bitcoin network.

19. A non-transitory computer readable storage medium configured to store instructions that, when executed by a processor included in a computing device, cause the computing device to carry out steps that include:
receiving a join request from a user, wherein the join request corresponds to a request to establish one or more channels with respective user nodes of a plurality of user nodes in a second-layer payment protocol network configured to process transactions between users associated with a cryptocurrency network;
obtaining information about the second-layer payment protocol network, wherein the information indicates channels established between the plurality of user nodes and at least one of (i) balances associated with the plurality of user nodes in the second-layer payment protocol network or (ii) balances associated with channels between two or more of the plurality of user nodes;
simulating, based on the information obtained about the second-layer payment protocol network, a plurality of transactions between selected user nodes of the plurality of user nodes to obtain transaction simulation results, wherein the transaction simulation results include at least reliability scores associated with the plurality of user nodes;
identifying one or more recommended user nodes based on the transaction simulation results and the information obtained about the second-layer payment protocol network; and
providing, to the user, an output indicating the one or more recommended user nodes.

20. The non-transitory computer readable storage medium of claim 19, wherein the transaction simulation results further include collected fees scores associated with the plurality of user nodes.

21. The non-transitory computer readable storage medium of claim 19, wherein identifying the one or more recommended user nodes includes performing discrete optimization on the information obtained about the second-layer payment protocol network.

22. The non-transitory computer readable storage medium of claim 19, wherein identifying the one or more recommended user nodes includes (i) constructing, based on the information obtained about the second-layer payment protocol network, an adjacency matrix of the second-layer payment protocol network, and (ii) applying a discrete optimization algorithm to the adjacency matrix to identify the one or more recommended user nodes.

23. The non-transitory computer readable storage medium of claim 22, further comprising (i) constructing an unraveled vector of the adjacency matrix and (ii) providing, as inputs to the discrete optimization algorithm, the unraveled vector, the transaction simulation results, and a number of the one or more user nodes indicated by the join request.

24. The non-transitory computer readable storage medium of claim 23, wherein the discrete optimization algorithm is at least one of a genetic algorithm and a Nelder-Mead algorithm.

25. The non-transitory computer readable storage medium of claim 19, further comprising (i) generating, based on the information obtained about the second-layer payment protocol network, a graph neural network (GNN) and (ii) simulating the plurality of transactions based on the GNN.

26. The non-transitory computer readable storage medium of claim 25, further comprising:
constructing, based on the GNN, an adjacency matrix of the second-layer payment protocol network; and
applying a discrete optimization algorithm to the adjacency matrix to identify the one or more recommended user nodes.

27. The non-transitory computer readable storage medium of claim 19, wherein the second-layer payment protocol network comprises the Lightning Network, and wherein the cryptocurrency network comprises the Bitcoin network.
